(19) United States
(12) Patent Application Publication
(10) Pub. No.: US 2004/0071144 A1
(43) Pub. Date: Apr. 15, 2004

(54) Method and system for distributed single-stage scheduling

(76) Inventors: Ofer Beeri, Be'er Sheva (IL); Eyal Nagar, Modi'in (IL); Shimshon Jacobi, Rehovot (IL)

Correspondence Address: NATH & ASSOCIATES, PLLC, Sixth Floor, 1030 15th Street, N.W., Washington, DC, 20005, US

(21) Appl. No.: 10/600,357

(22) Filed: Jun. 23, 2003

(30) Foreign Application Priority Data
Oct. 10, 2002 (IL) 152233

(51) Int. Cl. H04L 12/28

(52) U.S. Cl. 370/395.4; 370/415

(57) ABSTRACT

A method and distributed scheduler for use therewith has at least two clusters of source port modules, each tracking all queues associated with a respective input-node and relating to a respective subset of available input-nodes. Each source port module receives available output-nodes, and generates a weight for each queue therein. Each source port module generates at least one request relating to the highest weight serviceable queue. The respective requests of each source port module are accumulated, and for each cluster of source port modules, the request is chosen for which no two requests relate to the same input-node, and for each output-node, the chosen requests have highest weight. The highest weight request from all clusters is determined in respect of each output node receiving requests from one or more input nodes. A grant is sent to the input-node having the highest weight request.

### FIELD OF INVENTION

The present invention relates to the field of communication networks, and particularly to real-time packet scheduling in packet switched networks.

### REFERENCES

In the following discussion of the prior art, reference will be made to the following publications.

WO 01/33778 published May 10, 2001 in the name of the present applicant and entitled “Method and apparatus for high-speed, high-capacity packet-scheduling supporting quality of service in communications networks”.

U.S. Pat. No. 5,500,858 (McKeown), published March 1996 and entitled “Method and apparatus for scheduling cells in an output-queued switch”;

US patent application publication No. US 2001/0026558 A1 (Satoshi Kamiya), published October 2001 and entitled “Distributed pipeline scheduling method and system”.

IL 150281 filed Jun. 18, 2002 in the name of the present applicant and entitled “Method and system for multicast and unicast scheduling”.

### BACKGROUND OF THE INVENTION

As Internet traffic volume increases at an exponential rate, the search for high-performance and scalable packet-switching technologies is broadening. Traffic passing through the Internet is not only increasing in volume but also becoming more demanding in terms of quality of service (QoS). Examples of QoS parameters are packet delay, packet delay variation and packet loss. Existing and emerging multimedia applications, such as voice and video, which are growing more prevalent, require strict channel characteristics in order to function properly.

Broadband network infrastructures are coarsely composed of two basic building blocks: (1) high-speed point-to-point links and (2) high-performance network switching devices. While reliable high-speed point-to-point communications have been demonstrated using optical technologies, network switching devices such as switches and routers that can efficiently manage extensive amounts of diversely characterized traffic loads are still being developed. Hence, reduction of the bottleneck of communication network infrastructures has shifted towards designing such high-performance switches and routers.

It is generally acknowledged that the two main goals of network switches are (1) to utilize the available internal bandwidth optimally while at the same time (2) supporting QoS requirements. Constraints derived from these goals typically contradict in the sense that maximal bandwidth utilization does not necessarily mutually correlate to the support of the most urgent traffic flows. This concept has spawned a vast range of scheduling adaptation schemes, each seeking to offer high capacity, large number of ports and low latency requirements.

Many of these schemes employ output-queuing mechanisms, which means that packets (ATM, IP or any other type of packets) arriving at the input-node are transmitted through the cross-connect fabric to designated queues at output-nodes. In order to overcome collision in an N-by-N cross-connect fabric (N being the number of ports), either N-squared independent channels or circuitry capable of switching packets N times faster than the fastest input port's speed must be employed. Considering today's high line rates and large port count, N times faster circuitry is infeasible. Internal links are valuable resources making the realization of N-squared such links wasteful and infeasible.

Typical designs apply either centralized-queuing or output-queuing mechanisms in order to maximize switch bandwidth. However, as line rates and port densities increase, both centralized queuing and output queuing are found impractical.

An alternative to output-queuing is input-queuing, wherein cell buffering is managed at the switch input stage. It is well known that an input-queued switch employing a single FIFO at each input-node may achieve a maximum of 58.6% throughput due to the head-of-line (HOL) blocking phenomenon. A well-practiced technique, which entirely eliminates the HOL blocking, is Virtual Output Queuing (VOQ). In VOQ each input-node maintains a separate queue for each output. Arriving packets are classified at a primal stage to queues corresponding to the packet's designated destination. Such information is typically available within the packet header. In general, the goal of a scheduling mechanism is to determine, at any given time, which queue is to be served, i.e. permitted to transfer packets to its destined output.

Several scheduling algorithms have been proposed for VOQ switches.

Most high-performance algorithms known to date are too complex to be implemented in hardware and are found unsuitable for switches with high port densities and high line rates. Moreover, the algorithms proposed are commonly evaluated under uniform traffic conditions, which clearly does not represent real life traffic. As the traffic becomes less uniform and more bursty, these algorithms usually suffer from severe performance degradation. One method of enhancing VOQ-based switching is to increase the internal “speedup” of the switch. A switch with a speedup of L can transport L packets to any single output-node in one packet-time (packet time is the time period in which one packet arrives at the fastest input port). However, as mentioned above, the switching-core speed is a paramount resource limited by available technology, making speedup a drawback of any scheduling approach. In order to support QoS, VOQ is frequently expanded by assigning different queues (as opposed to just one) for each destination, whereby each queue corresponds to a distinct QoS class. Contention for transmission is thus carried out not only among queues in different input ports relating to the same destination port, but also among different class queues in any single input port designated for the same destination.

Although known scheduling algorithms focus on packets of fixed length, many network protocols, such as IP, have variable length packets. Most switching engines today segment these packets into fixed-length packets (or “cells”) prior to entering the switch fabric. The original packets are reconstructed at the output stage. This methodology is commonly practiced in order to achieve high performance. Accordingly, the methods described here may apply to both fixed and variable length packets.

Currently deployed scheduling algorithms practice some variation of a Round Robin scheme in which each queue is scanned in a cyclic manner. These schemes suffer from many disadvantages, including deficient support of global QoS provisioning and limited scalability with respect to line speeds and port densities. The latter is an extreme weakness of these schemes owing to the demand for connectivity of order N-squared. As a result, switch resources are not optimally exploited yielding limited switching performance.

One suggested solution to the above-mentioned problem is splitting the switch into several smaller switches; each having its own scheduler. This method is known as multistage scheduling, and although each scheduler is simple and can reach fast and optimized decisions in its own local environment, the overall result is not optimized, since no optimization is made for the whole system.

Other methods carry out more sophisticated scheduling approaches, which better exploit the switch resources. Still, these methods are complex and require relatively long processing periods, thus limiting the supported data rate, since decisions related to optimal scheduling are not produced in real-time.

It would therefore clearly be desirable to provide a fast, real-time, scalable, high-capacity packet scheduling solution, which supports QoS in high-speed packet switched networks.

Recently, a new scheduling algorithm and architecture were proposed (Ref. No. 1) which satisfy the above-mentioned requirements. For better understanding and readability the description of the present invention will be described with reference to this scheduling algorithm and architecture, but it can be applied to other scheduling algorithms and architectures as well.

The present invention deals with the issue of scheduling data packets transport from input-nodes (IN) to output-nodes via a cross-connect. The scheduling is done in the scheduler, whose aim is to match input nodes to output nodes (grants). The scheduler decides which input nodes will transmit data to which output nodes according to its scheduling algorithm. This process of grant generation is called arbitration and is done at least once in each timeslot (TS). One or more arbitration iterations (Al) fit in each time slot. To generate these grants efficiently the scheduler should have some picture concerning the virtual output queues (VOQs) condition in each input node and each output-node buffer condition. It is assumed that each input-node has its own weight generator, which generates each VOQ weight and reflects it to the scheduler. The VOQ weight may be updated during the arbitration process.

The scheduler can be divided into two main modules: source (ingress) port module (SPM) and scheduler core module (SCM). The inputs of the source port module are the VOQs' weights of its input-nodes and the offered-destination-set (ODS), which are the available output-nodes in the current iteration. The outputs of the source port module and which are fed to the scheduler core module are requests for grant, each request being an identity of a desired output-node (which is a member of the offered-destination-set) and its corresponding weight. The inputs of the scheduler core module are the source port module's requests, and its output is a set of grants.

When an output-node is granted it should be removed from the offered-destination-set (by the offer generator, OG) until the end of the current time slot. If the physical switching unit (crossbar) within the switch fabric (SF) allows each input-node to be connected with only one output-node during each time-slot (unicast), then each granted source port module stops its participation in the arbitrations until the end of the current time slot (i.e. it stops issuing requests). On the other hand, if the physical switching unit allows the connectivity of more than one output node with each input-node during the same time slot (multicast) then the granted source port module remains participating until it reaches the maximum allowed number of grants (Ref. No. 4). Many times, especially from the implementation point of view, it is desired to distribute the scheduler function between several chips or other separate units (physically distributed scheduler) to reduce the central scheduling unit stress, while keeping the advantage of a single-stage scheduler. Moreover, usually for a single-chip scheduler a pipelined process is preferred, where for distributed scheduler a pipelined arbitration become even more important.

### SUMMARY OF THE INVENTION

It is an object of the present invention to provide a method and apparatus for scheduling data packets transport from input-nodes to output-nodes via a cross-connect for lumped as well as for distributed schedulers with a variable number of pipeline stages.

To this end, there is provided in accordance with a first aspect of the invention a method for scheduling data packets transported from input-nodes to output-nodes said data packets being associated with a set of N input-nodes each having a plurality of M queues each for queuing data packets for routing to one or more corresponding M output-nodes, said method comprising:

(a) providing at least two clusters of source port modules, each source port module tracking all queues associated with a respective input-node and each cluster relating to a respective subset of available input-nodes such that each input node is associated with a respective one of said clusters,

(b) for each queue in each source port module destined to an available output node, generating a weight reflecting an urgency of said queue to transmit its queued cells towards the corresponding output-node,

(c) for each source port module tracking a serviceable queue, generating at least one request relating to the serviceable queue having highest weight,

(d) accumulating the respective requests of each source port module in the corresponding cluster of source port modules,

(e) for each cluster of source port modules, choosing requests for which:

i) no two requests in the cluster relate to the same input-node, and

ii) for each output-node, the chosen requests have highest weight for said output-node,

(f) collecting requests from all clusters of source port modules, and determining the highest weight request in respect of each output node receiving requests from one or more input nodes,

(g) sending a grant to the input-node associated with the highest weight request,

(h) removing the output-node associated with the said highest weight request from the available output node set,

(i) removing the input-node associated with the said highest weight request from the available input node set, unless the input-node needs to send the highest weight request to one or more additional output-nodes, and

(j) repeating (a) to (i) as required.

In accordance with a second aspect of the invention there is provided a scheduler for scheduling data packets transported from input-nodes to output-nodes, said data packets being associated with a set of N input-nodes each having a plurality of M queues each for queuing data packets for routing to a corresponding one of M output-nodes, said scheduler comprising:

at least two clusters of source port modules associated with respective subsets of input nodes for determining a highest weight queue for each input node in the respective subset associated with each cluster of source port modules,

a scheduler core module coupled to all of the clusters of source port modules for determining to which output node to route the highest weight queue from each input node,

a grant unit coupled to the scheduler core module for matching the output-node with the input-node having the highest priority request, and

a switching unit responsively coupled to the grant unit for enabling each input-node to transfer data to the respective output-node matching said input node.

The invention provides an efficient way to optimize the scheduler performance with respect to the number of pipeline stages and to allow efficient scheduling for distributed scheduler. The aim of this distribution is to reduce load on the scheduler core module.

A distributed scheduler according to the invention contains one or more Source Port Module Clusters (SPMCs), each of them has some of the capabilities of the scheduler core module. Such capabilities as can be distributed between the source port module clusters are the first stage of competition and the generation of the offered-destination set. In the first stage of competition, which is called the cluster competition stage, the choice of highest-weight-request for each requested output-node is carried out. This stage of cluster competition is carried out in a Maximum Cluster Determination Unit (MCDU). The maximum cluster determination unit can be designed or configured to support numerous choice policies (e.g. transfer to the SCM only the highest request for each output node, transfer the two highest requests, transfer only limited number of requests, etc.), which allows the support of all kinds of scheduling algorithms and implementations. When the generation of the offered-destination-set is distributed, each source port module cluster must contain a local offer generator unit (LOGU). In most cases all the LOGUs in the system (in the source port module clusters and in the scheduler core module) should be synchronized. Aggregating the source port modules into clusters and detaching the clusters from the scheduler core module result in substantial simplification of the scheduler core module. The simplification is in the input part of the scheduler core module as well as in complexity of calculation.

The offer generator (either the global offer generator in the scheduler core module or the local offer generator in the respective source port module cluster) generates the offered-destination-set and distributes it to all source port modules. The basic input of the offered-destination-set is the valid destinations set (VDS), which is a set of available output nodes. An output node may be removed from the valid destinations set or returned to the valid destinations set during the system operation as results from a flow-control message, system configuration change, or any other reason. For example, if it is found during operation that a port currently shown as connected is no longer viable, then the corresponding output node will be disconnected. It will be re-connected when subsequently found to be viable. In this way the system can support a large number of output nodes and yet allow higher efficiency when not all the output nodes are active (i.e. provide a large valid destinations set with many non-valid output nodes, which can become active whenever necessary). In this context, it should be understood that the scheduler may be designed for more ports than are actually connected in a specific implementation. Those ports that are not actually connected in a specific implementation are termed “non-valid”. For example, if the scheduler is capable of supporting 100 ports, but only 70 are connected, then, until the remaining 30 ports are connected, the VDS size is 100 with 30 non-valid output-nodes.

The preferred embodiment of the offer generator (the scheduler core module offer generator or the LOGU) has several types of offered-destination-sets:

1. Full set of valid destinations set-based orthogonal offers—set of orthogonal offers (i.e. each output node suggested only once in this set) that contains all the output nodes in the valid destinations set.

2. Partial sets of valid destinations set-based orthogonal offers subsets of (1) above.

3. Unmatched offered destination set (UODS) based offers—offers that are based on the UODS, which are the destinations that were offered but were not granted.

The offer generator can work in several modes, which can be any combination of the above sets. The best combination is system dependent and it is affected by the set size, valid destinations set size, number of arbitrations per time slot, number of pipeline stages etc. In addition, the order of the offers in a set is “weight dependent” in such a manner that in the current time slot the offer generator offers first the output nodes that had the higher weights in the previous time slot.

In all cases the offered-destination-set is masked by the unmatched destination set (UDS), which is a set of all the unmatched output nodes. The masking, which can be implemented as a vector of AND gates, ensures that even if the granted output node is in the offered-destination-set, it will be removed and not be requested again by the source port modules.

For pipelined scheduling some further masking mechanisms are added to leverage the granting efficiency (i.e. get more grants per number of system ports, N). Each source port module masks its requested VOQs until the end of the current time slot, or until the grant information from the scheduler core module is available to the source port module, whichever comes first.

The source port module max (SPMM) applies additional VOQ masking policy, which is weight-dependent. In such case the lower weight VOQs are masked in the first iterations in the time slot, at least until the higher weight VOQs are requested. This ensures that the lower weight VOQs will not be granted first, blocking the higher weight ones only because of the offer's order. Some variations of this masking (weight dependent masking in the first iterations) are:

1. Allowing the participations of the highest weight VOQ only.

2. Always allowing the participations of VOQs with weight higher than some threshold.

3. Allowing the participations of all VOQs unless at least one of the VOQ has weight higher than some threshold.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram showing functionally the distributed scheduler main entities and the main scheduler core module units;

FIG. 2 is a block diagram showing functionally the main blocks of the source port module cluster shown in FIG. 1; and

FIG. 3 is a flow diagram of a method of pipelined scheduling using the distributed scheduler shown in FIGS. 1 and 2.

### DETAILED DESCRIPTION OF SPECIFIC EMBODIMENTS

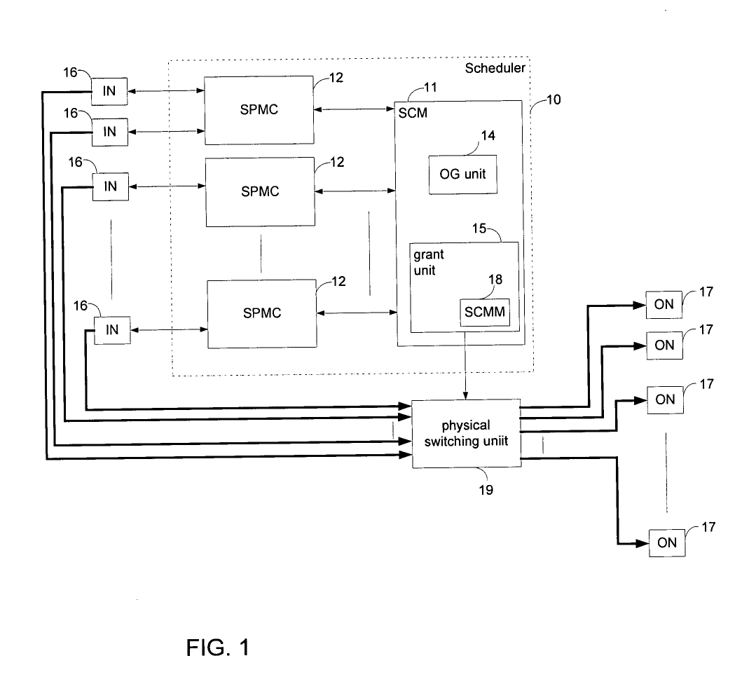

FIG. 1 shows functionally a distributed scheduler 10 according to the invention, whose main scheduler entities are a common scheduler core module 11 coupled to clusters 12 of source port modules 13 referred to as source port module clusters. The scheduler core module 11 includes an offer generator unit 14 and a grant unit 15, which includes the scheduler core module max 18. Input-nodes 16 are connected to the source port module clusters 12 inside the scheduler 10. Output-nodes 17 are connected to the input nodes 16 via a physical switching unit 19. The grant unit 15 is connected to the physical switching unit 19 to control its connectivity configuration (if the physical switching unit 19 allows for in-band configuration this connection can be eliminated). The data-path links are depicted by thicker lines.

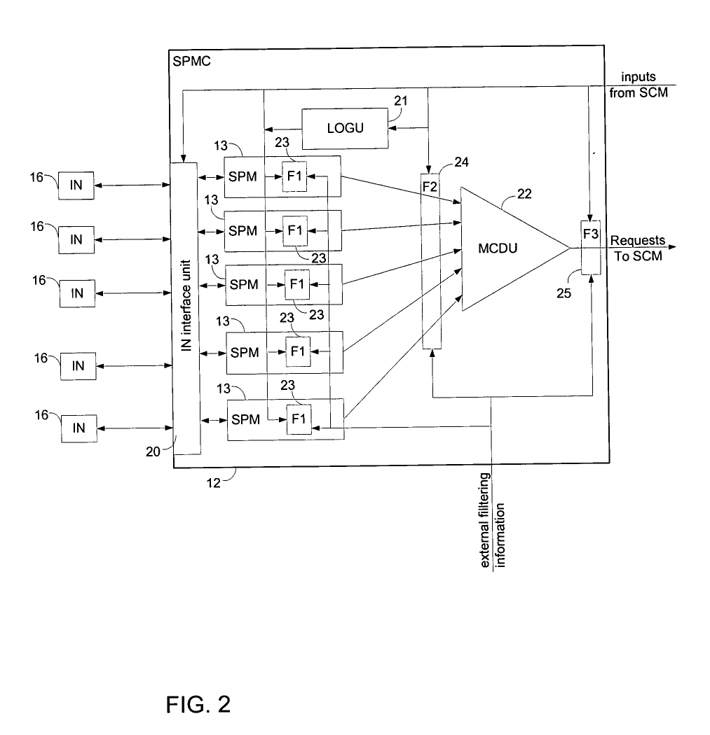

FIG. 2 shows schematically the main units, interfaces and features associated with the source port module clusters 12. Each source port module cluster 12 contains one or more source port modules 13 and some general blocks including a scheduler-input-nodes interface unit 20, a local offer generator unit (LOGU) 21, a maximum cluster determination unit (MCDU) 22 and filters (F1, F2, F3) 23, 24, 25. The filters 23, 24 and 25 are located at different critical points in the scheduling path so as to optimize performance as is explained in greater detail below.

As shown in FIG. 2, the filtering can be introduced in three places: in the source port modules (filter #1 23); between the source port modules and the maximum cluster determination unit 22 (filter #2 24); and after the maximum cluster determination unit (MCDU) 22 (filter #3 25). The location of these filters is variable. For example, filter #2 24, with minor changes, can be located inside the maximum cluster determination unit 22. Filter #1 23 handles information that is important for the generation of requests by the source port modules such as the information that one of the output nodes is not available and should not be requested. Filter #2 24 handles information that is more related to the source port module cluster such as the need for total screening of requests from a specified source port module. Filter #3 25 can be used for total screening of the source port module cluster requests or for “last moment” screening of requests. The exact filtering (masking) policy is determined by the combination of many factors, such as the number of pipeline stages, the current valid destinations set or grants history etc.

The input-nodes interface unit 20 is a smart interface that can handle complex distribution and modification of messages and serves as a communication module for the scheduler's input nodes that aggregates, modifies and redistributes the information streams, either in the Input-node-to-Scheduler or in the Scheduler-to-Input-node directions. The agglomeration of the source port modules in the source port module cluster allows for the use of less then one full interface per source port module, i.e. some of the interface modules may be shared by several source port modules.

The maximum cluster determination unit 22 chooses the highest-weight-request for each requested output node that was raised by more than one source port module 13 in the source port module cluster 12. The functionality of the source port module cluster 12 is equivalent to that of the scheduler core module max (SCMM) 18, but the location of the maximum cluster determination unit 22 inside the source port module cluster 12 allows more sophisticated usage. The different policies applied by the maximum cluster determination unit 22 may be implementation- or algorithm-dependent. Two examples of such policy are (i) allowing each output node to have more than one request and to screen it in the maximum cluster determination unit 22 after comparing it to the other source port module cluster requests; or (ii) transferring to the scheduler core module 11 only a limited number of requests, which is different than the number of source port modules 13 in the source port module cluster 12.

The source port module requests are transferred to the scheduler core module 11, after processing and filtering by the maximum cluster determination unit 22, for global arbitration and grant generation. The grant results are transferred from the scheduler core module 11 back to the source port module cluster 12. The grant results are fed into the source port modules and filters. When the offer generator 14 is distributed, the source port module cluster 12 contains a local offer generator unit as well. The ability of the local offer generator unit to generate the offered-destination-set saves the need to distribute the offered-destination-set from the offer generator 14 in the scheduler core module 11 to all the source port module clusters 12.

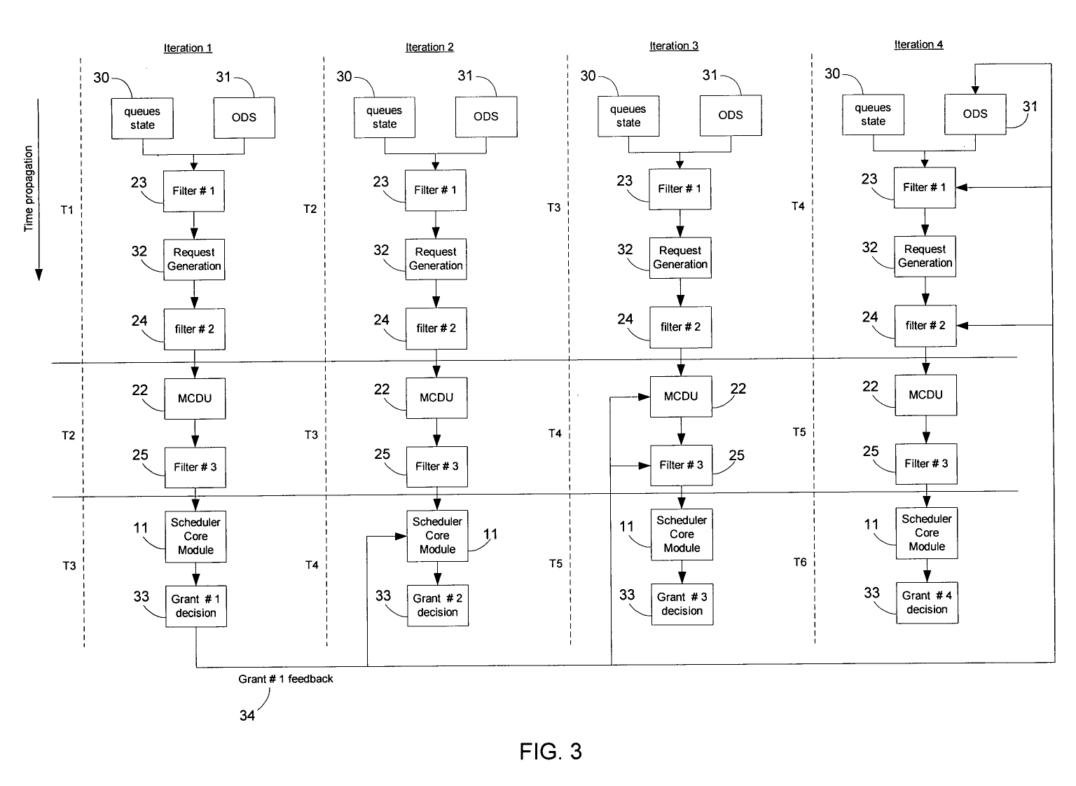

FIG. 3 is a flow diagram demonstrating four iterations of pipelined scheduling. T1, T2, T3, T4, T5 and T6 denote sequential single time units. Each scheduling iteration starts with each of the source port modules 13 making a request generation 32 according to the offered destination set 31, the queues' states 30 and the filtering information of filter #1 23. The queues' states 30 may be influenced by the length of the queues, the cells' waiting time etc, and is represented by a scalar weight. The request generation 32 is the stage where all queues that are included in the offered destination set 31, and not masked by filter # 1 23, compete inside the source port module 13 and the winner or winners are the ones to be requested. Examples of relevant information pertaining to the filter # 1 23 are the system flow control state and previous grants. In some configurations there may be more than one winner and the source port module 13 may generate more than one request. The requests issued by the source port modules 13 are fed into filter #2 24 that can be located inside the source port modules 13 just before the egress, or outside the source port modules 13 just before the maximum cluster determination unit 22. Filter #2 24 should mask source port module 13 as results of previous grants or any other source port related reason. The requests from the source port modules 13, after passing filter #2 24, enter maximum cluster determination unit 22, where all the requests for the same destination generated by the different source port modules 13 in the same source port module cluster 12, compete with each other. The winning requests are fed to filter #3 25 which handles parameters relating to source port module cluster 12, such as limiting the maximum number of requests transferred to the scheduler core module 11 by the cluster or relevant information relating to previous grants. After exit from filter #3 25, the requests leave the source port module cluster 12 and enter the scheduler core module 11, where the grant generation 33 takes place. The grant decision ends the iteration and is the result of global competition between all requests for grant to the same output node 17. This global competition takes place inside the scheduler core module max 18.

FIG. 3 demonstrates three pipeline phases scheduling. To save scheduling time, each successive scheduling iteration is started immediately in the next time period after the previous iteration has started; hence iteration 1 starts at time period T1, iteration 2 starts at time period T2 etc. For efficient scheduling a grant feedback is desirable, such as that denoted by the feedback loop grant # 1 feedback 34. Since the grant is generated only in the time period T3, it is available only for actions that take place from time period T4 and later. The use of three pipeline phases is by way of example only and the same approach can be scaled to any other number of pipeline phases, with the main change being during which iteration the grant feedback 34 is available.

It will be understood that while pipelined scheduling is often advantageous it is particularly beneficial in the invention because the scheduler 10 is distributed and different components thereof are configured to generate requests such that ideally at each stage of the scheduling process progressively fewer requests are passed on to the next stage. Pipelining introduces delays between each stage of an iteration for delaying the requests in order to comply with any internal or external constraint. Thus, in the example shown in FIG. 3 where each iteration is processed in three discrete stages, two delays are introduced: one between the first and second stages and another between the second and third stages. Pipelining improves efficiency since once each stage has forwarded its requests to the next stage, it is then free to generate requests for the next iteration. So, for example, once the source port module 13 has passed its requests to the maximum cluster determination unit 22, it is then free to commence the next iteration in time period T2. Were pipelining not employed the source port module 13 would have to wait until the end of the grant stage at time period T3 before commencing its next iteration in time period T4. Feedback from the grant decision allows each stage of the scheduler to operate more efficiently. By way of example, where one of two or more input nodes competing for the same output node was granted, the granted input node can be removed from consideration during a subsequent iteration so as to save processing time and increase processing efficiency. Likewise, an output node that has been granted can be removed from consideration during a subsequent iteration so as to save processing time and to increase processing efficiency.

Although pipelining improves efficiency, it will however be appreciated that the scheduler may still be used without pipelining if desired.

Regardless of whether pipelining is used or not, filtering also reduces the number of requests that must be processed during a subsequent iteration and thereby improves efficiency of the scheduler. At each stage of the scheduler, the filters receive updated snapshots of available input-nodes and of available output-nodes, and remove requests outgoing from the source port module if either (1) the request is from an input node which is not a member of the updated snapshot of the available input-nodes, or (2) the request is for an output node which is not a member of the updated snapshot of the available output-nodes.

1. A method for scheduling data packets transported from input-nodes to output-nodes said data packets being associated with a set of N input-nodes each having a plurality of M queues each for queuing data packets for routing to one or more corresponding M output-nodes, said method comprising:
(a) providing at least two clusters of source port modules, each source port module tracking all queues associated with a respective input-node and each cluster relating to a respective subset of available input-nodes such that each input node is associated with a respective one of said clusters,
(b) for each queue in each source port module destined to an available output node, generating a weight reflecting an urgency of said queue to transmit its queued cells towards the corresponding output-node,
(c) for each source port module tracking a serviceable queue, generating at least one request relating to the serviceable queue having highest weight,
(d) accumulating the respective requests of each source port module in the corresponding cluster of source port modules,
(e) for each cluster of source port modules, choosing requests for which:
i) no two requests in the cluster relate to the same input-node, and
ii) for each output-node, the chosen requests have highest weight for said output-node,
(f) collecting requests from all clusters of source port modules, and determining the highest weight request in respect of each output node receiving requests from one or more input nodes,
(g) sending a grant to the input-node associated with the highest weight request,
(h) removing the output-node associated with the said highest weight request from the available output node set,
(i) removing the input-node associated with the said highest weight request from the available input node set, unless the input-node needs to send the highest weight request to one or more additional output-nodes, and
(j) repeating (a) to (i) as required.

2. The method according to claim 1, wherein successive phases of an iteration are pipelined so as to allow independent components of a scheduler carrying out the method to operate in parallel.

3. The method according to claim 1, further including at least one filtering operation to improve performance of said method.

4. The method according to claim 3, wherein the at least one filtering operation comprises:
i) receiving updated snapshots of available input-nodes and of available output-nodes,
) removing requests outgoing from the source port module if either:
(1) said request is from an input node which is not a member of the updated snapshot of the available input-nodes, or,
(2) said request is from an input node which is not a member of the updated snapshot of the available output-nodes.

5. The method according to 3, wherein the at least one filtering operation handles information that is important for the generation of requests by the source port modules.

6. The method according to claim 2, further including at least one filtering operation to improve performance of said method.

7. The method according to claim 6, wherein the at least one filtering operation comprises:
i) receiving updated snapshots of available input-nodes and of available output-nodes,
) removing requests outgoing from the source port module if either:
(1) said request is from an input node which is not a member of the updated snapshot of the available input-nodes, or,
(2) said request is from an input node which is not a member of the updated snapshot of the available output-nodes.

8. The method according to 6, wherein the at least one filtering operation handles information that is important for the generation of requests by the source port modules.

9. The method according to claim 3, wherein the at least one filtering operation handles information relating to the source port module.

10. The method according to claim 3, wherein the at least one filtering operation is used for total screening of the source port module cluster requests or for “last moment” screening of requests.

11. A scheduler for scheduling data packets transported from input-nodes to output-nodes, said data packets being associated with a set of N input-nodes each having a plurality of M queues each for queuing data packets for routing to a corresponding one of M output-nodes, said scheduler comprising:
at least two clusters of source port modules associated with respective subsets of input nodes for determining a highest weight queue for each input node in the respective subset associated with each cluster of source port modules,
a scheduler core module coupled to all of the clusters of source port modules for determining to which output node to route the highest weight queue from each input node,
a grant unit coupled to the scheduler core module for matching the output-node with the input-node having the highest priority request, and
a switching unit responsively coupled to the grant unit for enabling each input-node to transfer data to the respective output-node matching said input node.

12. The scheduler according to claim 11, wherein each cluster of source port modules includes a maximum cluster determination unit for choosing the highest-weight-request for each requested output node that was raised by more than one source port module in the source port module cluster.

13. The scheduler according to claim 11, further including at least one filter to improve scheduling efficiency.

14. The scheduler according to claim 13, wherein the at least one filter is located in each of the source port modules.

15. The scheduler according to claim 13, wherein the at least one filter is located after the source port modules.

16. The scheduler according to claim 12, further including at least one filter to improve scheduling efficiency.

17. The scheduler according to claim 16, wherein the at least one filter is located in each of the source port modules.

18. The scheduler according to claim 16, wherein the at least one filter is located after the source port modules.

19. The scheduler according to claim 12, further including at least one filter located after the maximum cluster determination unit to improve scheduling efficiency.

20. The scheduler according to claim 11, wherein independent components thereof operate in parallel so as to allow pipelined scheduling.
